(19) United States
(12) Patent Application Publication
(10) Pub. No.: US 2025/0242532 A1
(43) Pub. Date: Jul. 31, 2025

(54) SELF-REINFORCING THERMOPLASTIC COMPOSITE MATERIALS, AND METHODS OF MANUFACTURING SELF-REINFORCING THERMOPLASTIC COMPOSITE MATERIALS

(71) Applicants: GM GLOBAL TECHNOLOGY OPERATIONS LLC, Detroit, MI (US); VIRGINIA TECH INTELLECTUAL PROPERTIES, INC., Blacksburg, VA (US)

(72) Inventors: Mary GILLIAM, Farmington Hills, MI (US); Ryan Gergely, Fraser, MI (US); Selina Xinyue Zhao, Rochester Hills, MI (US); Michael Bortner, Blacksburg, VA (US); Cailean Pritchard, Blacksburg, VA (US); David A. Okonski, Waterford, MI (US)

(21) Appl. No.: 18/428,563

(22) Filed: Jan. 31, 2024

(51) Int. Cl. B29C 48/00; B29C 48/05; B29K 81/00; B29K 105/00; B29K 105/10; B29K 507/00; C08K 3/36; C08L 81/02

(52) U.S. Cl. CPC B29C 48/022; B29C 48/05; C08K 3/36; C08L 81/02; B29K 2081/04; B29K 2105/0079; B29K 2105/106; B29K 2105/251; B29K 2507/00

(57) ABSTRACT

A thermoplastic composite elongate extrudate having a thermoplastic polymer matrix material with a plurality of elongate thermoplastic liquid crystal polymer fibrils generally aligned with the direction of extrusion. A method of making a thermoplastic composite includes mixing a thermoplastic polymer matrix material and a thermoplastic liquid crystal polymer, where the viscosity of the thermoplastic polymer matrix material is sufficiently greater than the viscosity of the thermoplastic liquid crystal polymer, and extruding the mixture to create a composite elongate extrudate comprising a thermoplastic polymer matrix material with a plurality of elongate thermoplastic liquid crystal polymer fibrils generally aligned with the direction of extrusion.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to self-reinforcing thermoplastic composite materials, and to methods of manufacturing self-reinforcing thermoplastic composite materials.

A composite material is a material which is produced from two or more constituent materials, often having dissimilar properties, which are merged to create a material with properties unlike the constituents. One class of composite materials is reinforced plastics such as fiber-reinforced polymer or fiberglass. Reinforced plastic composite materials are frequently used for structural parts, and are increasingly used in general automotive applications. However, these materials can be difficult and expensive to manufacture, and difficult to recycle.

### SUMMARY

Further areas of applicability of the present disclosure will become apparent from the detailed description, the claims, and the drawings. The detailed description and specific examples are intended for purposes of illustration only and are not intended to limit the scope of the disclosure.

Embodiments of this disclosure provide a thermoplastic extruded composite comprising thermoplastic polymer matrix material with a plurality of elongate thermoplastic liquid crystal polymer fibrils generally aligned with the direction of extrusion. The elongate thermoplastic liquid crystal polymer fibrils can comprise between about 20 wt % and about 80 wt % of the composite extrudate.

The thermoplastic polymer matrix material can comprise a wide variety of thermoplastic polymers, co-polymers, and mixtures thereof, including but not limited to PA6 (Nylon 6), PA66 (Nylon 66), PA12 (Nylon 12), PA6,66 (Nylon 6-66), PPS (polyphenylene sulfide), PEI (polyetherimide), PEEK (polyether ether ketone), PEKK (polyetherketoneketone), PAEK (polyaryletherketone), PET (polyethylene terephthalate), PC (polycarbonates), ABS (acrylonitrile butadiene styrene), and PP (polypropylene). In general, any thermoplastic materials that are adhesive to liquid crystal polymer and dispersible to liquid crystal polymer can be a suitable matrix material.

The thermoplastic liquid crystal polymer material can comprise a variety of thermotropic liquid crystal polymers, including but not limited to Vectra B950, Xydar SRT-900, as long as liquid crystal polymer is compatible with the matrix material, which is determined by the rheological properties (viscosity and elasticity), and interfacial tension between the components.

Embodiments of this disclosure also provide a method of making a thermoplastic composite extrudate comprising thermoplastic polymer matrix material with a plurality of elongate thermoplastic liquid crystal polymer fibrils. The method can comprise mixing a thermoplastic liquid crystal polymer with a thermoplastic polymer matrix having a viscosity sufficiently greater than the viscosity of the thermoplastic liquid crystal polymer at the extruding temperature, so that extruding the mixture creates a composite extrudate comprising a thermoplastic polymer matrix material with a plurality of elongate thermoplastic liquid crystal polymer fibrils generally aligned with the direction of extrusion.

The ratio of the viscosity of the thermoplastic polymer matrix material to the viscosity of the thermoplastic liquid crystal polymer at the extruding temperature is greater than about 2, and can be between about 2 and about 1000. A viscosity enhancer can be added to the thermoplastic polymer matrix material. The viscosity enhancer can be at least one multi-walled carbon nanotubes, carbon black, nano-clays, such as montmorillonite, and silicates. In some embodiments the viscosity enhancer is more miscible with the thermoplastic polymer matrix material than the thermoplastic liquid crystal polymer. In addition, or alternatively, a viscosity reducer can be added to the thermoplastic liquid crystal polymer material. The viscosity reducer can be boron nitride and/or fumed silica. In at least some embodiments, the viscosity reducer is more miscible with the thermoplastic liquid crystal polymer material than the thermoplastic polymer matrix material.

The thermoplastic polymer matrix material can comprise a wide variety of thermoplastic polymers, co-polymers, and mixtures thereof, including but not limited to PA6 (Nylon 6), PA66 (Nylon 66), PA12 (Nylon 12), PA6,66 (Nylon 6-66), PPS (polyphenylene sulfide), PEI (polyetherimide), PEEK (polyether ether ketone), PEKK (polyetherketoneketone), PAEK (polyaryletherketone), PET (polyethylene terephthalate), PC (polycarbonates), ABS (acrylonitrile butadiene styrene), and PP (polypropylene). In general, any thermoplastic material whose minimum processing temperature of the matrix material does not exceed the thermal or rheological processing conditions of the thermoplastic liquid crystal polymer material, and has compatible viscosity, elasticity, and interfacial tension, can be a suitable matrix material.

The thermoplastic liquid crystal polymer material comprises a variety of thermotropic liquid crystal polymers. In general, any polymer with a main chain consisting of repeating units of aromatic rings linked together or with linking organic groups that can form liquid crystal phases, such as commercially available Vectra® grades, Zenite® grades, Xydar® grades, and similar, can be used including but not limited to Vectra B950, Xydar SRT-900, as long as liquid crystal polymer is compatible with the matrix material, and the minimum supercooled processing temperature of the thermoplastic liquid crystal polymer material does not exceed the onset of thermal or rheological degradation of the matrix material.

The mixture of thermoplastic polymer matrix material and thermoplastic liquid crystal polymer can be extruded from a single screw extruder to create a filament. This filament can be used for fused filament fabrication, or it can be pelletized.

The mixture of thermoplastic polymer matrix material and a thermoplastic liquid crystal polymer can include a compatibilizer to improve the interfacial bonding between the thermoplastic liquid crystal polymer and the thermoplastic polymer matrix. This compatibilizer can comprise at least one of an ionomer, a copolymer, maleic anhydride, PEEK, other thermoplastic liquid crystal polymers, polyester imides. The performance of the compatibilizer/ionomer/copolymer can be evaluated by testing the preliminary morphological behavior of the blend to have improved adhesion and dispersion in much finer scale than other blends.

The mixture of thermoplastic polymer matrix material and a thermoplastic liquid crystal polymer can include a stabilizer. This stabilizer can be at least one of polystyrene, poly (methyl methacrylate), or single-walled carbon nanotubes. Increasing the molar ratio of the acid in the copolymer formulation of the thermoplastic liquid crystal polymer phase will generally increase LC stability.

### BRIEF DESCRIPTION OF THE DRAWINGS

The present disclosure will become more fully understood from the detailed description and the accompanying drawings, wherein:

FIG. 1 is a schematic diagram of the equipment for making a thermoplastic extruded composite comprising thermoplastic polymer matrix material with a plurality of elongate thermoplastic liquid crystal polymer fibrils according to the principles of this disclosure;

FIG. 2 is a photomicrograph showing the cross-section of a filament of a thermoplastic extruded composite comprising thermoplastic polymer matrix material with a plurality of elongate thermoplastic liquid crystal polymer fibrils in accordance with embodiments of this disclosure;

FIG. 3 is an enlarged photomicrograph of a portion of the cross-section shown in FIG. 2;

FIG. 4 is a flow chart of one embodiment of a process for making a thermoplastic extruded composite comprising thermoplastic polymer matrix material with a plurality of elongate thermoplastic liquid crystal polymer fibrils according to the principles of this disclosure;

FIG. 5 is a photomicrograph of a self-reinforcing thermoplastic composite material according to Example 1 of this disclosure; and

FIG. 6 is a photomicrograph of a self-reinforcing thermoplastic composite material according to Example 2 of this disclosure.

In the drawings, reference numbers may be reused to identify similar and/or identical elements.

### DETAILED DESCRIPTION

Embodiments of this disclosure provide a thermoplastic extruded composite comprising thermoplastic polymer matrix material with a plurality of elongate thermoplastic liquid crystal polymer fibrils generally aligned with the direction of extrusion. These fibrils can have diameters on the order of 1-10 μm in some embodiments, and 1-5 μm in other embodiments. Generally, the diameters of the fibrils can be controlled by changing the relative viscosities of the liquid crystal polymer and the thermoplastic matrix during the extrusion process. The fibrils can have a tensile modulus in the range of 35-70 GPa, and the overall extrudate can have a tensile modulus in the range of 20-40 GPa. The extrusion can be in the form of a thin (e.g., 3 mm to 8 mm in diameter), elongate extrudate. The elongate thermoplastic liquid crystal polymer fibrils can comprise between about 20 wt % and about 80 wt % of the composite extrudate, and in some embodiments between about 40 wt % and about 60 wt % of the composite extrudate.

The thermoplastic polymer matrix material can comprise a wide variety of thermoplastic polymers, co-polymers, and mixtures of thereof, including but not limited to PA6 (Nylon 6), PA66 (Nylon 66), PA12 (Nylon 12), PA6,66 (Nylon 6-66), PPS (polyphenylene sulfide), PEI (polyetherimide), PEEK (polyether ether ketone), PEKK (polyetherketoneketone), PAEK (polyaryletherketone), PET (polyethylene terephthalate), PC (polycarbonates), ABS (acrylonitrile butadiene styrene), and PP (polypropylene). In general, any thermoplastic material whose minimum processing temperature does not exceed the thermal or rheological processing conditions of the thermoplastic liquid crystal polymer material, and has compatible viscosity, elasticity, and interfacial tension, can be a suitable matrix material. can be a suitable matrix material.

The thermoplastic liquid crystal polymer material can comprise comprises a variety of thermotropic liquid crystal polymers, including but not limited to Vectra B950 and Xydar SRT-900, as long as liquid crystal polymer is compatible with the matrix material, and the minimum supercooled processing temperature of the thermoplastic liquid crystal polymer material does not exceed the onset of thermal or rheological degradation of the matrix material. A thermoplastic liquid crystal polymer material with a melting point in the range of 275-305° C. can be combined with polymers with melting points of ˜270-350° C., such as PPS or PEI, while a thermoplastic liquid crystal polymer material with a melting point in the range of 320-360° C. can be combined with polymers with melting points of ˜310-400° C., such as PEI, PEKK, PAEK, and PEEK.

Embodiments of this disclosure also provide a method of making a thermoplastic composite extrudate comprising thermoplastic polymer matrix material with a plurality of elongate thermoplastic liquid crystal polymer fibrils. One such process is indicated generally as 20 in FIG. 4. As shown in FIG. 4, at 22 a thermoplastic liquid crystal polymer and a thermoplastic polymer matrix are loaded into the barrel of an extruder. The thermoplastic liquid crystal polymer and the thermoplastic polymer matrix are selected so that when heated to the extruding temperature, the ratio of the viscosity of the thermoplastic polymer matrix material to viscosity of the thermoplastic liquid crystal polymer is at least about 2 to 1, in order for the fibrils to form during extrusion.

As discussed above, the thermoplastic polymer matrix material can comprise a wide variety of thermoplastic polymers, co-polymers, and mixtures of thereof, including but not limited to PA6 (Nylon 6), PA66 (Nylon 6), PA12 (Nylon 12), PA6,66 (Nylon 6-66), PPS (polyphenylene sulfide), PEI (polyetherimide), PEEK (polyether ether ketone), PEKK (polyetherketoneketone), PAEK (polyaryletherketone), PET (polyethylene terephthalate), PC (polycarbonates), ABS (acrylonitrile butadiene styrene), and PP (polypropylene). In general, any thermoplastic material whose minimum processing temperature of the matrix material does not exceed the thermal or rheological processing conditions of the thermoplastic liquid crystal polymer material can be a suitable matrix material.

As also discussed above, the thermoplastic liquid crystal polymer material can comprise a variety of thermotropic liquid crystal polymers, including but not limited to Vectra B950 (an aromatic co (polyester amide) with 2,6-dihydroxynaphthoic acid (HNA), p-amino phenol (AP) and terephthalic acid (TA) with the molar ratios of 60/20/20) and Xydar SRT-900 (a copolymer of 4-hydroxybenzoic acid, 4,4′-biphenol and terephthalic acid), as long as liquid crystal polymer is compatible with the matrix material, and the minimum supercooled processing temperature of the thermoplastic liquid crystal polymer material does not exceed the onside of thermal or rheological degradation of the matrix material.

Prior to or after being loaded into the extruder, one or more viscosity enhancers can be added to the thermoplastic polymer matrix material to attain or maintain a desired relationship between the viscosities of the thermoplastic polymer matrix material and the thermoplastic liquid crystal polymer. The viscosity enhancer can be at least one of multi-walled carbon nanotubes, carbon black, nano-clays, such as montmorillonite, boron nitride, and silicates. The viscosity enhancer can be added to the thermoplastic polymer matrix material at about 1 to about 10 wt % loading of the polymer matrix material. In at least some embodiments, particularly where the viscosity enhancer is added in the presence of the thermoplastic liquid crystal polymer, it may be desirable that the viscosity enhancer be more miscible with the thermoplastic polymer matrix material than the thermoplastic liquid crystal polymer.

Prior to or after being loaded into the barrel of the extruder, one or more viscosity reducers can be added to the thermoplastic liquid crystal polymer to attain or maintain a desired relationship between the viscosities of the thermoplastic polymer matrix material and the thermoplastic liquid crystal polymer. The viscosity reducer can be nanoparticles that are polymeric, metallic, or ceramic, such as fumed silica. The viscosity reducer can be added to the thermoplastic liquid crystal polymer material at about 1 to about 2 wt % loading of the liquid crystal polymer material. In at least some embodiments, particularly where the viscosity reducer is added in the presence of the thermoplastic polymer matrix material, it may be desirable that the viscosity reducer is more miscible with the thermoplastic liquid crystal polymer material than the thermoplastic polymer matrix material.

A compatibilizer can be added to the mixture of thermoplastic polymer matrix material and thermoplastic liquid crystal polymer to improve the interfacial bonding between the thermoplastic liquid crystal polymer and the thermoplastic polymer matrix. This compatibilizer can comprise at least one of an ionomer, a copolymer, maleic anhydride, PEEK, other thermoplastic liquid crystal polymers, polyester imides. In particular, an ionomer of sulfonated polystyrene may improve interfacial adhesion between the liquid crystal polymer and the thermoplastic matrix.

A stabilizer can be added to the mixture of thermoplastic polymer matrix material and thermoplastic liquid crystal polymer as UV stabilizer to prevent discoloration under UV exposure. This stabilizer can be at least one of polystyrene, poly (methyl methacrylate), or single-walled carbon nanotubes.

At 24 the thermoplastic polymer matrix material and the thermoplastic liquid crystal polymer mixture are passed through one or more static mixers. As discussed above, it is desirable that the ratio of the viscosity of the thermoplastic polymer matrix material to the viscosity of the thermoplastic liquid crystal polymer at the extruding temperature is greater than about 2, can be as high as 1000 or higher.

At 26, the mixture of thermoplastic polymer matrix material and thermoplastic liquid crystal polymer can be extruded from a single screw extruder to create a filament. In some embodiments, the extrusion pressure is at least about 15 KPa. At 28 the filament can pass through an optional water bath to cool and solidify the filament. The filament can then pass to a take-up winder and spooled for use in fused filament fabrication, or it can be pelletized.

One avenue for the fabrication of a filament for 3D printing is to first compound the LCP and matrix material and pelletize it without much care or consideration for fibril formation—the fibrils would then be produced in the subsequent processing step which uses the compounded pellets to produce a filament for fused filament fabrication. In other words, pellets containing both the thermoplastic polymer matrix material and thermoplastic liquid crystal polymer can be used as the starting material to produce a self-reinforcing thermoplastic composite filament according to the embodiments of this disclosure, for use in 3D printing fused filament fabrication.

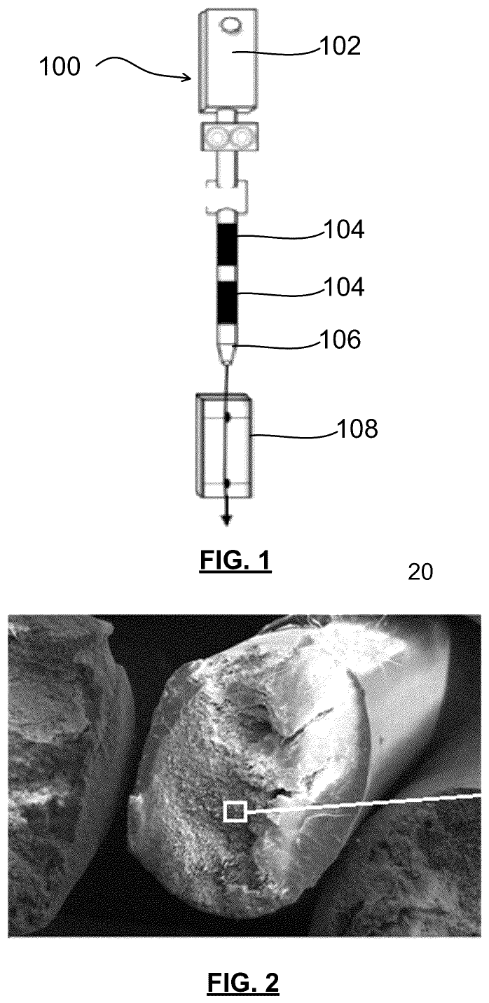

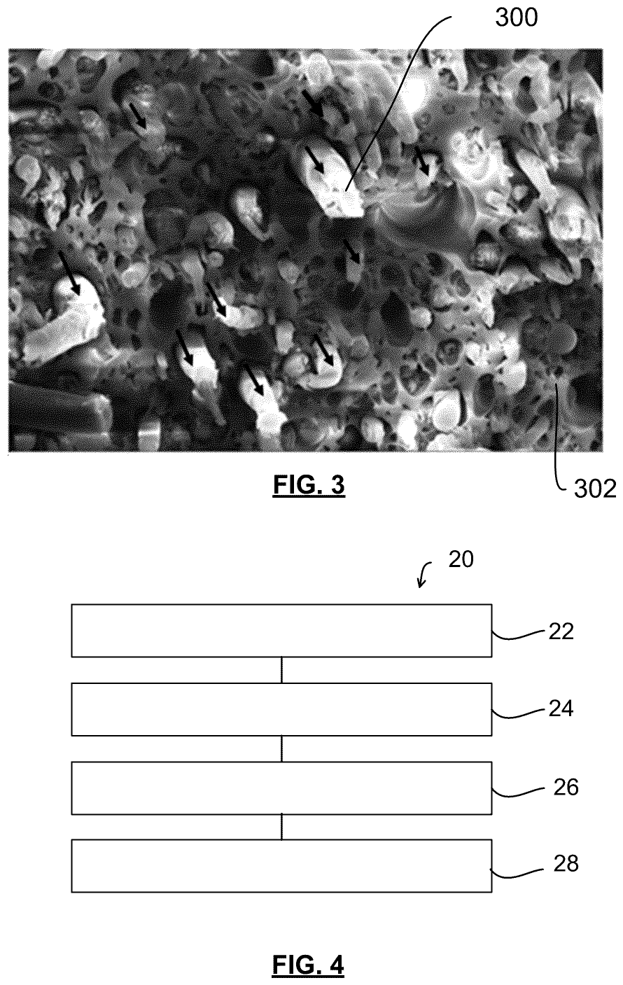

A system for implementing the method 20 is indicated generally as 100 in FIG. 1. System 100 includes a barrel 102 for melting the thermoplastic polymer matrix material and thermoplastic liquid crystal polymer, or at least softening them sufficiently so they can be mixed. Typical temperature range would be above the liquid crystal phase-isotropic phase transition of the thermoplastic liquid crystal polymer and between about 570° F. and about 610° F.

The system 100 further includes one or more static mixers 104 for mixing the thermoplastic polymer matrix material and thermoplastic liquid crystal polymer and any viscosity enhancers or reducers, compatibilizers, and stabilizers.

The system 100 also has an extrusion head 106 for extruding an elongate filament. This filament is preferably cooled in a water bath 108, after which it can pass to a take up winder or to a pelletizer.

### Example 1

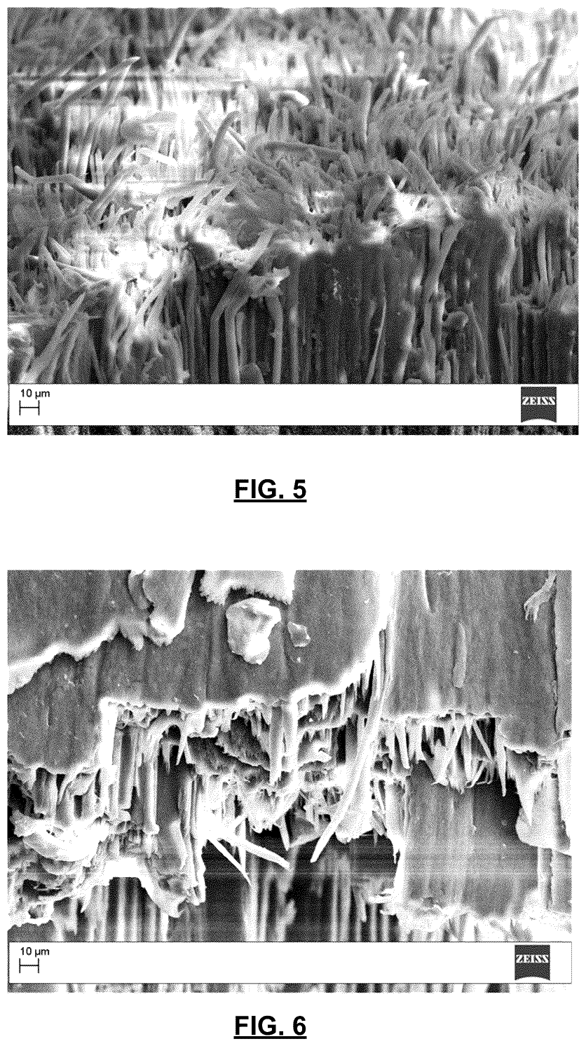

A mixture of 40% by weight Vectra B950 having a neat viscosity or about 50 Pa·s and 60% by weight polyphenylene sulfide with a neat viscosity of about 190 Pa·s measured at 325° C. with 1 Hz shearing rate, was compounded using a twin screw extruder and subsequently injection molded. The mixture was heated to a temperature of about 325° C., which is above the liquid crystal phase-isotropic phase transition temperature of the Vectra B950, which occurs between about 300-310° C. Tensile test bars were prepared in the mold, which was at a temperature of 127° C. The resulting sample was a wholly thermoplastic composite material consisting of a liquid crystal polymer fibril reinforced polymer matrix. Tensile testing resulted in a modulus of 10 GPa and a tensile strength of 79 MPa. The image in FIG. 5 of the broken portion of the tensile sample shows the presence of liquid crystal polymer fibrils of Vectra B950 and a matrix of PPS.

The inventors posit that maintaining a viscosity ratio of the thermoplastic polymer matrix material to the thermoplastic liquid crystal polymer of at least 2:1 facilitates the formation of the liquid crystal polymer fibrils.

The material can be injection molded at a high production rate and with improved surface properties compared to thermoset composites. It also can be recycled and used in a similar application due to the re-melting and forming of new fibrils in the subsequent process.

### Example 2

A mixture of 40 wt % of Vectra® B950 (LCP), 55 wt % of Fortron® polyphenylene sulfide (PPS), and 5 wt % of fumed silica (FS) was compounded using a twin screw extruder and subsequently injection molded. The compounded material was prepared by mixing the FS with the PPS prior to addition of the LCP. In the injection molding process, the temperature of the melt exiting the barrel at 315° C. was such that the LCP was an isotropic melt. The viscosity ratio of the PPS-FS mixture to the LCP was about 13.5. Tensile test bars were prepared in the mold that had a temperature of 140° C. to enable transition of the LCP from isotropic to liquid crystal phase and formation of fibrils. Tensile testing resulted in a modulus of 13 GPa and a tensile strength of 107 MPa. The image in FIG. 6 of the broken portion of the tensile sample shows the presence of liquid crystal polymer fibrils of Vectra B950 and a matrix of PPS.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the term “about” means+/−10% of a specified value. As used herein, the phrase at least one of A, B, and C should be construed to mean a logical (A OR B OR C), using a non-exclusive logical OR, and should not be construed to mean “at least one of A, at least one of B, and at least one of C.”

1. A thermoplastic composite elongate extrudate comprising thermoplastic polymer matrix material with a plurality of elongate thermoplastic liquid crystal polymer fibrils generally aligned with the direction of extrusion.

2. The thermoplastic composite elongate extrudate according to claim 1 wherein the elongate thermoplastic liquid crystal polymer fibrils comprise between about 20 wt % and about 80 wt % of the composite elongate extrudate.

3. The thermoplastic composite elongate extrudate according to claim 1 wherein the thermoplastic polymer matrix material comprises at least one of PA6 (Nylon 6), PA66 (Nylon 66), PA12 (Nylon 12), PA6,66 (Nylon 6-66), PPS (polyphenylene sulfide), PEI (polyetherimide), PEEK (polyether ether ketone), PEKK (polyetherketoneketone), PAEK (polyaryletherketone), PET (polyethylene terephthalate), PC (polycarbonates), ABS (acrylonitrile butadiene styrene), and PP (polypropylene).

4. The thermoplastic composite elongate extrudate according to claim 1 wherein the thermoplastic liquid crystal polymer fibrils comprises at least one of any polymer with a main chain consisting of repeating units of aromatic rings, linked together or with linking organic groups, that can form liquid crystal phases.

5. A method of making a thermoplastic composite elongate extrudate comprising mixing a thermoplastic polymer matrix material and a thermoplastic liquid crystal polymer, the thermoplastic polymer matrix material having a viscosity sufficiently greater than the viscosity of the thermoplastic liquid crystal polymer at the extruding temperature, that extruding the mixture to create a composite elongate extrudate comprising a thermoplastic polymer matrix material with a plurality of elongate thermoplastic liquid crystal polymer fibrils generally aligned with the direction of extrusion.

6. The method of making a thermoplastic composite according to claim 5, wherein the ratio of the viscosity of the thermoplastic polymer matrix material to the viscosity of the thermoplastic liquid crystal polymer at the extruding temperature is greater than about 2.

7. The method of making a thermoplastic composite according to claim 5 wherein the thermoplastic polymer matrix material comprises at least one of PA6 (Nylon 6), PA66 (Nylon 66), PA12 (Nylon 12), PA6,66 (Nylon 6-66), PPS (polyphenylene sulfide), PEI (polyetherimide), PEEK (polyether ether ketone), PEKK (polyetherketoneketone), PAEK (polyaryletherketone), PET (polyethylene terephthalate), PC (polycarbonates), ABS (acrylonitrile butadiene styrene), and PP (polypropylene).

8. The method of making a thermoplastic composite according to claim 5, wherein the thermoplastic liquid crystal polymer comprises at least one polymer with a main chain consisting of repeating units of aromatic rings linked together or with linking organic groups that can form liquid crystal phases.

9. The method of making a thermoplastic composite according to claim 5 wherein the step of extruding the mixture is performed with a single screw extruder to create a filament suitable for fused filament fabrication.

10. The method of making a thermoplastic composite according to claim 5 wherein the elongate extrudate is pelletized.

11. The method of making a thermoplastic composite according to claim 5 further comprising adding a viscosity enhancer to the thermoplastic polymer matrix material.

12. The method of making a thermoplastic composite according to claim 11 wherein the viscosity enhancer is at least one multi-walled carbon nanotubes, carbon black, nano-clays, and silicates.

13. The method of making a thermoplastic composite according to claim 11 wherein the viscosity enhancer is more miscible with the thermoplastic polymer matrix material than the thermoplastic liquid crystal polymer.

14. The method of making a thermoplastic composite according to claim 5 further comprising adding a viscosity reducer to the thermoplastic liquid crystal polymer material.

15. The method of making a thermoplastic composite according to claim 14 wherein the viscosity reducer is at least one of boron nitride and/or fumed silica.

16. The method of making a thermoplastic composite according to claim 14 wherein the viscosity reducer is more miscible with the thermoplastic liquid crystal polymer material than the thermoplastic polymer matrix material.

17. The method according to claim 5 wherein the mixture of thermoplastic polymer matrix material and a thermoplastic liquid crystal polymer includes a compatibilizer to improve the interfacial bonding between the thermoplastic liquid crystal polymer material and the thermoplastic polymer matrix.

18. The method according to claim 17 wherein the compatibilizer comprises at least one of an ionomer and/or a copolymer.

19. The method according to claim 5 wherein the mixture of thermoplastic polymer matrix material and a thermoplastic liquid crystal polymer includes a stabilizer.

20. The method according to claim 19 wherein the stabilizer is at least one of polystyrene, poly (methyl methacrylate), or single-walled carbon nanotubes.
